(19) United States
(12) Patent Application Publication
(10) Pub. No.: US 2006/0036785 A1
(43) Pub. Date: Feb. 16, 2006

(54) Media broadcasting device having USB slot

(76) Inventors: Ming-Hui Tseng, Tao Yuan Hsien (TW); Chuan-Chung Chen, Taipei Hsien (TW); Shih-Ming Chen, Taipei City (TW); Fok-Kei Loo, Taipei City (TW); Mao-Wei Peng, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/914,182

(22) Filed: Aug. 10, 2004

(51) Int. Cl. G06F 13/12

(52) U.S. Cl. 710/62

(57) ABSTRACT

A media-broadcasting device having USB slots is described. The media-broadcasting device connects to a USB-based memory device through the USB slot and has a main controller connected to the memory device through the USB slot for access to digital data stored in the memory device, an interior memory buffer connected to the main controller for temporarily storing the digital data under the command of the main controller, and an MP3 module connected to the main controller for retrieving and processing the digital data through the main controller.

### BACKGROUND OF THE INVENTION

1. Field of the Invention

The present invention relates to a media-broadcasting device having USB slots, and more particularly, to an MP3 media-broadcasting device having USB slots to connect a USB-based memory device, the media-broadcasting device thus directly controlling and having access to the memory device.

2. Description of the Prior Art

MP3 (MPEG audio layer 3) format has been widely accepted in modern mobile devices because the algorithm it adopts for data compressing is highly efficient, by which an ordinary audio file (wav-formatted) becomes only one-tenth of its original size. Furthermore, even with compressions and de-compressions, the quality of the audio file is not significantly changed. Consequently, MP3-formatted files have gradually become one preference when it comes to file format selection for mobile devices.

Meanwhile, the USB-based data transmission interface has already become the mainstream in the modern market because of its high data transmission rate, and thus is widely used in general multimedia applications such as MP3-formatted file transmission and graphic data transmission for digital cameras.

However, the data transmission of the MP3 media-broadcasting device of prior arts complies with the master-servant architecture, meaning both outgoing and incoming data are controlled by the computer rather than by the media-broadcasting device. Even the mobile memory device for the purpose of data backup is also under the control of the computer, and thus cannot directly access the data in the MP3 broadcasting device.

### SUMMARY OF THE INVENTION

It is therefore a primary objective of the present invention to provide a USB-based slot connected to a USB memory device in a removable manner. After the memory device is connected with the USB-based slot, the main controller of the media-broadcasting device controls and has access to the digital data stored in the USB memory device. By doing so, the MP3 broadcasting device no longer has to connect to the computer to retrieve the digital data in the storage device connected to the computer.

In accordance with the claimed invention, the present invention provides a media-broadcasting device with USB-based slots. The media-broadcasting device includes a main controller connected to the USB memory device through the USB slot, so as to control and have access to the digital data stored inside the USB memory device. The broadcasting device further includes an interior memory buffer connected to the main controller for being controlled by the main controller so as to store temporarily the digital data from the USB memory device, and an MP3 module connected to the main controller for retrieving the digital data from the interior memory buffer through the main controller. The MP3 module then processes the digital data from the interior memory buffer.

It is the advantage of the present invention that the media-broadcasting device according to the present invention includes a USB-based slot for directly connecting to USB memory devices. Therefore, the MP3 media-broadcasting device no longer needs to connect to -the computer, which traditionally controls the media-broadcasting device when it wants to access the digital data in the memory device of the computer.

These and other objectives of the present invention will no doubt become obvious to those of ordinary skill in the art after reading the following description of the preferred embodiment that is illustrated in the various figures and drawings.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the USB-based memory device of the present invention;

FIG. 2 is a circuit block diagram of the present invention USB-based memory device; and

FIG. 3 is a circuit block diagram of the MP3 module of the present invention media-broadcasting device.

### DETAILED DESCRIPTION OF THE PREFERRED EMBODIMENTS

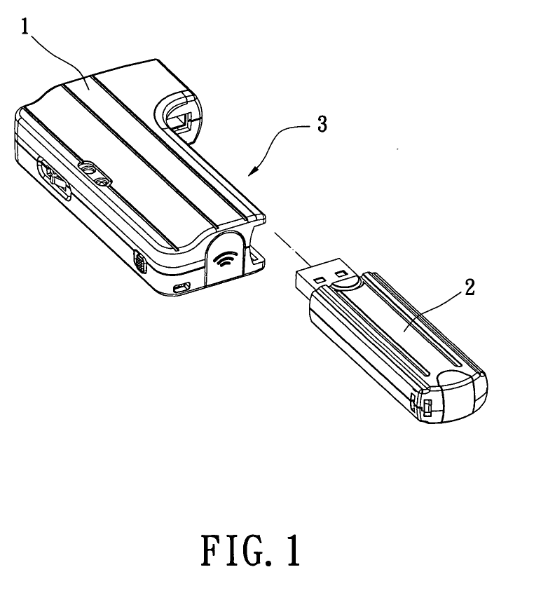

FIG. 1 is schematic diagram of a USB memory device according to the present invention. A media-broadcasting device 1 has at least one USB slot 3 having the USB memory device 2 connected in a removable manner. The media-broadcasting device 1, preferably an MP3 media-broadcasting device, connects to the USB memory device 2 so as to have direct access to the MP3-formatted data stored within the USB memory device 2.

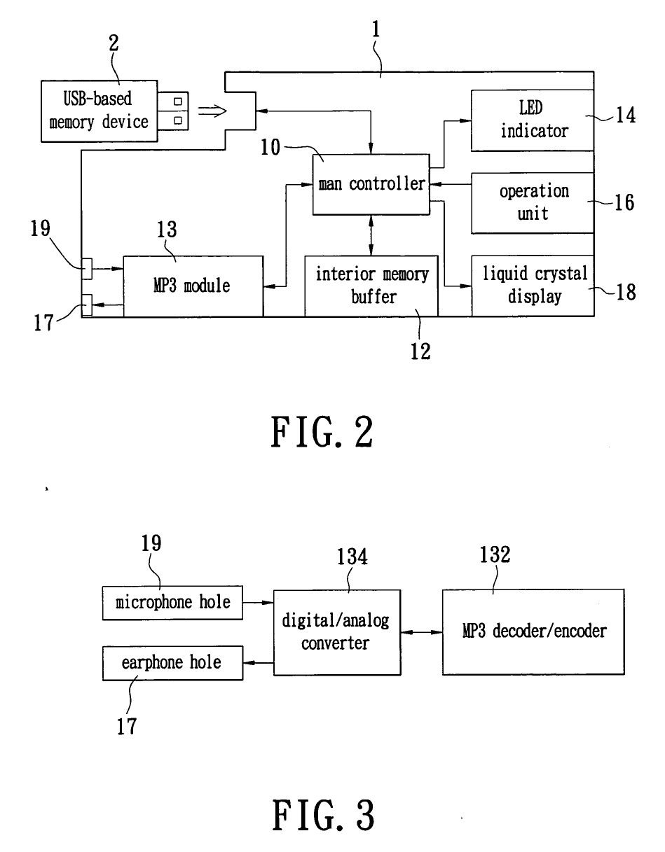

FIG. 2 is a circuit block diagram illustrating the USB memory device based on the present invention. The -media-broadcasting device 1 includes a main controller 10, an interior memory buffer 12, an MP3 module 13, an LED indicator 14, an operation unit 16, a liquid crystal display (LCD) 18, an earphone hole 17 and a microphone hole 19.

The main controller 10 connects to the USB-based memory device 2 (FIG. 1) through an interface controller (not shown) of the main controller 10 and the USB slot 3 (FIG. 1). Therefore, the main controller 10 controls and has access to the digital data (preferably, the MP3-formatted ones) of the USB memory device 2. The main controller 10 transmits the retrieved digital data to the interior memory buffer 12, which temporarily stores the digital data. The main controller 10 further connects to the MP3 module 13 and transmits the temporarily stored digital data within the interior memory buffer 12 to the MP3 module 13. The MP3 module processes the digital data, and therefore users are able to hear the sound (music) through the earphone hole 17. Similarly, users may choose to input their sound through the microphone hole 19 to the MP3 module 13, and the MP3 module 13 compresses the sound into MP3-formatted signals. Then the main controller 10 temporarily stores these MP3-formatted signals within the interior memory buffer 12 and also transmits the audio signals to the USB memory device 2.

The interface controller preferably is a USB-based interface controller. The interior memory buffer 12 consists of memories such as EEPROM, Flash-RAM, SDRAM and DRAM.

The main controller 10 simultaneously connects to the LED indicator 14, the operation unit 16 and the LCD 18. The LED indicator 14 is for indicating the operating status of the media-broadcasting device. The operation unit 16 connecting to the main controller 10 is for outputting an operation signal to the main controller 10 so as to switch operating modes and execute functions with respect to the corresponding operating modes. The operation unit 16 includes functions of power on/off, play/pause, volume adjustment, recording and song selecting. The LCD 18 is for displaying corresponding information regarding which song is currently playing and selectable functions of the media-broadcasting device 1.

FIG. 3 is a circuit block diagram of the present invention MP3 module 13 in conjunction with FIG. 2. The MP3 module 13 includes an MP3 decoder/encoder 132 and a digital/analog converter 134. The main controller 10 controls the MP3 decoder/encoder 132 to decode the MP3-formatted signals stored in the interior memory buffer 12 and then transmit the decoded signals to the digital/analog converter 134. Thereafter users may connect their earphones to the earphone hole 17 in order to hear the music.

The MP3 module 13 also receives the sound output from microphones connected to the microphone hole 19. The digital/analog converter 134 converts the sound into a corresponding digital format, and then the MP3 decoder/encoder 132 takes over to encode the sound into an MP3 format. The main controller 10 further temporarily stores the MP3-formatted signal in the interior memory buffer 12, thereby achieving the goal of human voice recordation. The main controller 10 also transmits the MP3-formatted signal to the USB-based memory device 2.

Users operate the operation unit 16 to output operation signals to the main controller 10. The main controller 10 therefore has access to the MP3-formatted digital data stored in the USB-based memory device 2 through the interface controller. The digital data retrieved by the interface controller is temporarily stored in the interior memory buffer 12, and then the main controller 10 transmits the data to the MP3 module 13 to broadcast the MP3 music. Microphones receive human voice (sound) and the MP3 module 13 processes the human sound (voice) and then the main controller 10 temporarily stores the MP3-formatted audio signals in the interior memory buffer 12 so as to record the human voice.

The interface controller preferably is a USB-based interface controller. Additionally, the interior memory buffer 12 consists of memories such as EEPROM, Flash-Ram, SDRAM, and DRAM.

At the point users operate the present invention media-broadcasting device through the operation unit 16, they can control the on/off of the power, play or pause the broadcast, adjust the volume, record, and select which song they want to play. The main controller 10 of the present invention media-broadcasting device enters an “idle” stage when no operation task is input. If no storage space of the interior memory buffer 12 is available when recording, the main controller 10 of the media-broadcasting device 1 removes data already stored in the interior memory buffer, so as to store the latest audio signals.

In contrast to the prior art media-broadcasting device, the present invention device has at least one USB slot for connecting the USB-based memory device in a removable manner. Therefore the media-broadcasting device has direct access to the digital data stored in the memory device without having to connect-to computers anymore.

Those skilled in the art will readily observe that numerous modifications and alterations of the device may be made while retaining the teachings of the invention. Accordingly, the above disclosure should be construed as limited only by the means and bounds of the appended claims.

What is claimed is:

1. A media-broadcasting device having USB slots connected to a USB-based memory device, comprising:
a main controller connected to the memory device through the USB slot for having access to digital data stored in the memory device;
an interior memory buffer connected to the main controller for temporarily storing the digital data under the command of the main controller; and.
an MP3 module connected to the main controller for retrieving and processing the digital data through the main controller.

2. The media broadcasting device of claim 1 further comprising an LED indicator connected to the main controller for indicating an operating status of the media-broadcasting device.

3. The media broadcasting device of claim 1, further comprising an operation unit connected to the main controller for outputting an operation signal to the main controller so as to switch operating modes and execute functions with respect to corresponding operating modes.

4. The media-broadcasting device of claim 1, further comprising a liquid crystal display (LCD) connected to the main controller.

5. The media broadcasting device of claim 1, wherein the main controller connects to the memory device through an interior interface controller therein to control and access the digital data within the memory device.

6. The media broadcasting device of claim 5, wherein the interface controller is a USB-based interface controller.

7. The media broadcasting device of claim 1, wherein the interior memory buffer consists of memories such as EEPROM, Flash-RAM, SDRAM and DRAM.

8. The media broadcasting device of claim 1, wherein the MP3 module further includes an MP3 decoder/encoder and a digital/analog converter connected to the MP3 encoder/decoder.
